(19) United States
(12) Patent Application Publication
(10) Pub. No.: US 2020/0307642 A1
(43) Pub. Date: Oct. 1, 2020

(54) VEHICLE CONTROL SYSTEM

(71) Applicant: HONDA MOTOR CO., LTD., Tokyo (JP)

(72) Inventors: Kanta TSUJI, Wako-shi (JP); Tadashi NARUSE, Wako-shi (JP)

(21) Appl. No.: 16/832,648

(22) Filed: Mar. 27, 2020

(30) Foreign Application Priority Data
Mar. 29, 2019 (JP) 2019067650

(51) Int. Cl. B60W 60/00; B60W 10/20; B60W 50/14; B60W 10/04; B60W 10/30; B60W 50/10

(52) U.S. Cl. CPC B60W 60/0053; B60W 10/20; B60W 50/14; B60W 2510/20; B60W 10/30; B60W 50/10; B60W 2510/0604; B60W 10/04

(57) ABSTRACT

A vehicle control system (1) configured for autonomous driving includes an autonomous driving mode in which the vehicle is operated without requiring an intervention of the driver at least in regard to steering or acceleration/deceleration of the vehicle, and an autonomous stopping mode in which the vehicle is brought to a stop in a prescribed stop area when it is detected that the control unit or the driver has become incapable of properly maintaining a traveling state of the vehicle. A control unit (15) transfers driving responsibility in regard to an operation input unit to the driver when an operation amount applied to the operation input unit exceeds a first threshold when an autonomous driving mode is being executed, and when an operation amount applied to the operation input unit exceeds a second threshold greater than the first threshold when an autonomous stopping mode is being executed.

### TECHNICAL FIELD

The present invention relates to a vehicle control system configured for autonomous driving.

### BACKGROUND ART

SAE J3016 defines six levels of autonomous driving. Level 0 corresponds to conventional manual driving, and level 5 corresponds to fully autonomous driving which requires no human intervention. However, depending on the surrounding environment, human intervention may be required. At such a time, the control system of the vehicle makes a handover request to the occupant, and request the occupant to take over the responsibility of driving. The potential driver however may not be able to take over the driving due to physical ailment or for other reasons. In such a situation, the control system executes a minimal risk maneuver (MRM) whereby the vehicle is autonomously driven to a safe part of the road, and is brought to a stop at a selected stop position.

JP6201927B discloses a vehicle control system which executes autonomous driving in certain regions such as expressways, and lets the driver manually operate the vehicle in other regions such as ordinary roads. When the driver is unable to take over the responsibility of driving, the vehicle control system brings the vehicle autonomously to a stop in an evacuation area which is determined in an emergency parking zone or a road shoulder located nearer to the current position than the area where the transfer of the driving responsibility was expected to take place.

However, this prior art fails to take into account of the possibility of the driver regaining the capability to take over the driving responsibility after a short spell of physical ailment. If the driver is able to intervene in the driving of the vehicle, the safety of the driving can be improved as compared to the case where the vehicle control system is allowed to execute the MRM autonomously.

### SUMMARY OF THE INVENTION

In view of such a problem of the prior art, a primary object of the present invention is to provide a vehicle control system configured for autonomous driving that allows the driver to readily take over the driving responsibility as soon as the driver recovers the capability to drive the vehicle in an MRM situation.

To achieve such an object, the present invention provides a vehicle control system (1) configured for autonomous driving, comprising: a control unit (15) for steering, accelerating and decelerating a vehicle; a notification interface (12) configured to notify a handover request issued by the control unit to a driver of the vehicle; and an intervention detection unit (10, 11, 13, 33) for detecting an intention of the driver to accept the handover request; wherein the autonomous driving includes an autonomous driving mode in which the vehicle is operated without requiring an intervention of the driver at least in regard to steering or acceleration/deceleration of the vehicle, and an autonomous stopping mode in which the vehicle is brought to a stop in a prescribed stop area when it is detected that the control unit or the driver has become incapable of properly maintaining a traveling state of the vehicle; and wherein the intervention detection unit includes an operation input unit configured to accept a steering operation and/or an accelerating/decelerating operation by the driver: the control unit transferring driving responsibility in regard to the operation input unit to the driver when an operation amount applied to the operation input unit exceeds a first threshold when the autonomous driving mode is being executed, and when an operation amount applied to the operation input unit exceeds a second threshold greater than the first threshold when the autonomous stopping mode is being executed. Transferring the driving responsibility as used herein means that the driver takes over the driving from the vehicle control system.

Thus, during execution of the autonomous stopping mode, if the driver performs a driving operation of a certain kind, the driver is allowed to take over the driving at least in regards to the driving operation of this kind. Furthermore, the threshold of the operation amount of the operation input unit for transferring the driving responsibility to the driver during the execution of the autonomous stopping mode is set to be greater than that during the execution of the autonomous driving mode so that the unintended operation of the operation input unit is disregarded, and the erroneous detection of an acceptance of driving responsibility can be avoided.

Preferably, the threshold is lowered gradually or in a stepwise manner with time after the vehicle is brought to a stop in the autonomous stopping mode.

Once the vehicle is brought to a stop, the transfer of driving responsibility can be performed more safely than before so that the convenience of the driver may be improved by lowering the threshold.

Preferably, the control unit at least partly transfers driving responsibility to the driver when an ignition key, a shift lever or a door lock device is operated after the vehicle is brought to a stop in the autonomous stopping mode.

Since the vehicle can be readily restarted by operating a device other than the operation input unit directly related to the driving of the vehicle after the vehicle is brought to a stop in the autonomous stopping mode, the convenience of the driver can be enhanced. Since the vehicle is stationary, the restarting the vehicle by the operation of the ignition key, the shift lever or the door lock device does not affect the safety of the vehicle.

Preferably, the operation input unit includes a steering wheel, an accelerator pedal and a brake pedal, and when operation amounts of the steering wheel and the accelerator pedal both exceed the second threshold, or when operation amounts of the steering wheel and the brake pedal both exceed the second threshold, the driving responsibility in regard to the associated part of the operation input unit is transferred to the driver.

Thus, since the operation amounts of the steering wheel and the accelerator pedal or the operation amounts of the steering wheel and the brake pedal are both required to exceed the second threshold for the driving responsibility to the transferred to the driver, the transfer of the driving responsibility can take place only when the driver has deliberately or intentionally operated the relevant part of the operation input unit.

Preferably, the operation input unit includes a steering wheel, an accelerator pedal and a brake pedal, and the intervention detection unit includes a grip sensor (28) provided on the steering wheel to detect if the driver is holding the steering wheel. Furthermore, the control unit transfers the driving responsibility to the driver when the grip sensor indicates that the vehicle is holding the steering wheel in the autonomous driving mode, and transfers the driving responsibility to the driver when the grip sensor indicates that the driver is holding the steering wheel, and the operation amount of the operation input unit exceeds the second threshold in the autonomous stopping mode.

Thus, it requires not only that the operation amount of the operation input unit exceeds the second threshold but also that the driver is holding the steering wheel for the driving responsibility to be transferred to the driver in the autonomous stopping mode. Therefore, the driving responsibility is transferred to the driver only when the driver consciously intends to drive the vehicle.

Preferably, the vehicle control system further comprises a hazard lamp that can be turned on to indicate an activation of the autonomous stopping mode, and a manual switch to turn off the hazard lamp, and the driving responsibility is transferred to the driver when the hazard lamp which was turned on upon activation of the autonomous stopping mode is manually turned off by the driver.

According to this arrangement, the driving responsibility can be transferred to the driver also when the driver has manually turned off the hazard lamp so that the convenience of the driver can be enhanced. Since the hazard lamp is not likely to be inadvertently pressed, the possibility of erroneously transferring the driving responsibility to a driver having no intention or capability to take over the driving can be minimized.

Preferably, the operation input unit includes a steering wheel, and the control unit is configured to apply a reaction force to the steering wheel opposing a steering input thereto when an operation amount applied thereto is below the threshold.

Due to the fact that the second threshold is higher than the first threshold, and a reaction force is applied to the steering wheel when the operation amount is equal to or lower than the threshold, the driver is prevented from inadvertently turning the steering wheel. The driver may be thus urged to take over the driving as a conscious effort when the driving responsibility is transferred to the driver who was unable to acknowledge the request to take over the driving when the operating mode of the vehicle switched from the autonomous driving mode to the autonomous stopping mode.

Preferably, in executing the autonomous stopping mode, when the operation amount exceeds a prescribed value higher than the second threshold, the control unit prevents a part of the operation amount exceeding the prescribed value from being reflected in controlling the vehicle.

The driver may overreact to the initiation of the autonomous stopping mode. However, the vehicle driver is prevented from excessively operating the operation input unit owing to the reduction in the operation amount by a part thereof exceeding the second threshold so that a sudden turning, a sudden acceleration, and a sudden braking are prevented.

The present invention thus provides a vehicle control system configured for autonomous driving that allows the driver to readily take over the driving responsibility as soon as the driver recovers the capability to drive the vehicle in an MRM situation.

### BRIEF DESCRIPTION OF THE DRAWING(S)

FIG. 1 is a functional block diagram of a vehicle on which a vehicle control system according to the present invention is mounted;

FIG. 2 is a flowchart of a stop process;

FIG. 3 is a diagram illustrating the changes in a threshold for an operation amount applied to an operation input unit with time;

FIG. 4 is a flowchart showing the process of transferring the driving responsibility to the driver in an autonomous driving mode;

FIG. 5 is a flowchart showing the process of transferring the driving responsibility to the driver in an autonomous stopping mode; and

FIG. 6 is a diagram illustrating the changes in the relationship between the operation amount and a corresponding control amount when the driving responsibility is transferred to the driver in the autonomous stopping mode.

### DESCRIPTION OF THE PREFERRED EMBODIMENT(S)

A vehicle control system according to a preferred embodiment of the present invention is described in the following with reference to the appended drawings. The following disclosure is according to left-hand traffic. In the case of right-hand traffic, the left and the right in the disclosure will be reversed.

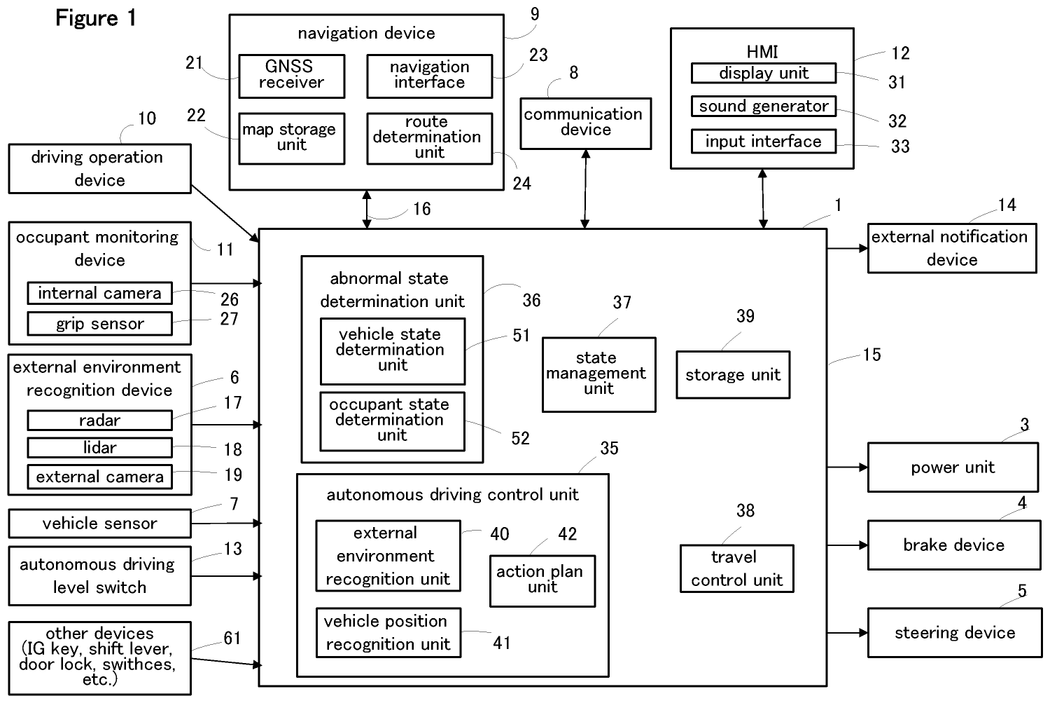

As shown in FIG. 1, the vehicle control system 1 according to the present invention is a part of a vehicle system 2 mounted on a vehicle. The vehicle system 2 includes a power unit 3, a brake device 4, a steering device 5, an external environment recognition device 6, a vehicle sensor 7, a communication device 8, a navigation device 9 (map device), a driving operation device 10, an occupant monitoring device 11, an HMI 12 (Human Machine Interface), an autonomous driving level switch 13, an external notification device 14, and a control unit 15. These components of the vehicle system 2 are connected to one another so that signals can be transmitted between them via a communication means such as CAN 16 (Controller Area Network).

The power unit 3 is a device for applying a driving force to the vehicle, and may include a power source and a transmission unit. The power source may consist of an internal combustion engine such as a gasoline engine and a diesel engine, an electric motor or a combination of these. The brake device 4 is a device that applies a braking force to the vehicle, and may include a brake caliper that presses a brake pad against a brake rotor, and an electrically actuated hydraulic cylinder that supplies hydraulic pressure to the brake caliper. The brake device 4 may also include a parking brake device. The steering device 5 is a device for changing a steering angle of the wheels, and may include a rack-and-pinion mechanism that steers the front wheels, and an electric motor that drives the rack-and-pinion mechanism. The power unit 3, the brake device 4, and the steering device 5 are controlled by the control unit 15.

The external environment recognition device 6 is a device that detects objects located outside of the vehicle. The external environment recognition device 6 may include a sensor that captures electromagnetic waves or light from around the vehicle to detect objects outside of the vehicle, and may consist of a radar 17, a lidar 18, an external camera 19, or a combination of these. The external environment recognition device 6 may also be configured to detect objects outside of the vehicle by receiving a signal from a source outside of the vehicle. The detection result of the external environment recognition device 6 is forwarded to the control unit 15.

The radar 17 emits radio waves such as millimeter waves to the surrounding area of the vehicle, and detects the position (distance and direction) of an object by capturing the reflected wave. Preferably, the radar 17 includes a front radar that radiates radio waves toward the front of the vehicle, a rear radar that radiates radio waves toward the rear of the vehicle, and a pair of side radars that radiates radio waves in the lateral directions.

The lidar 18 emits light such as an infrared ray to the surrounding part of the vehicle, and detects the position (distance and direction) of an object by capturing the reflected light. At least one lidar 18 is provided at a suitable position of the vehicle. The external camera 19 can capture the image of the surrounding objects such as vehicles, pedestrians, guardrails, curbs, walls, median strips, road shapes, road signs, road markings painted on the road, and the like. The external camera 19 may consist of a digital camera using a solid-state imaging device such as a CCD and a CMOS. At least one external camera 19 is provided at a suitable position of the vehicle. The external camera 19 preferably includes a front camera that images the front of the vehicle, a rear camera that images the rear of the vehicle and a pair of side cameras that image the lateral views from the vehicle. The external camera 19 may consist of a stereo camera that can capture a three-dimensional image of the surrounding objects.

The vehicle sensor 7 may include a vehicle speed sensor that detects the traveling speed of the vehicle, an acceleration sensor that detects the acceleration of the vehicle, a yaw rate sensor that detects an angular velocity of the vehicle around a vertical axis, a direction sensor that detects the traveling direction of the vehicle, and the like. The yaw rate sensor may consist of a gyro sensor.

The communication device 8 allows communication between the control unit 15 which is connected to the navigation device 9 and other vehicles around the own vehicle as well as servers located outside the vehicle. The control unit 15 can perform wireless communication with the surrounding vehicles via the communication device 8. For instance, the control unit 15 can communicate with a server that provides traffic regulation information via the communication device 8, and with an emergency call center that accepts an emergency call from the vehicle also via the communication device 8. Further, the control unit 15 can communicate with a portable terminal carried by a person such as a pedestrian present outside the vehicle via the communication device 8.

The navigation device 9 is able to identify the current position of the vehicle, and performs route guidance to a destination and the like, and may include a GNSS receiver 21, a map storage unit 22, a navigation interface 23, and a route determination unit 24. The GNSS receiver 21 identifies the position (latitude and longitude) of the vehicle according to a signal received from artificial satellites (positioning satellites). The map storage unit 22 may consist of a per se known storage device such as a flash memory and a hard disk, and stores or retains map information. The navigation interface 23 receives an input of a destination or the like from the user, and provides various information to the user by visual display and/or speech. The navigation interface 23 may include a touch panel display, a speaker, and the like. In another embodiment, the GNSS receiver 21 is configured as a part of the communication device 8. The map storage unit 22 may be configured as a part of the control unit 15 or may be configured as a part of an external server that can communicate with the control unit 15 via the communication device 8.

The map information may include a wide range of road information which may include, not exclusively, road types such as expressways, toll roads, national roads, and prefectural roads, the number of lanes of the road, road markings such as the center position of each lane (three-dimensional coordinates including longitude, latitude, and height), road division lines and lane lines, the presence or absence of sidewalks, curbs, fences, etc., the locations of intersections, the locations of merging and branching points of lanes, the areas of emergency parking zones, the width of each lane, and traffic signs provided along the roads. The map information may also include traffic regulation information, address information (address/postal code), facility information, telephone number information, and the like.

The route determination unit 24 determines a route to the destination according to the position of the vehicle specified by the GNSS receiver 21, the destination input from the navigation interface 23, and the map information. When determining the route, in addition to the route, the route determination unit 24 determines the target lane which the vehicle will travel in by referring to the merging and branching points of the lanes in the map information.

The driving operation device 10 receives an input operation performed by the driver to control the vehicle. The driving operation device 10 may include a steering wheel, an accelerator pedal, and a brake pedal. Further, the driving operation device 10 may include a shift lever, a parking brake lever, and the like. Each element of the driving operation device 10 is provided with a sensor for detecting an operation amount of the corresponding operation. The driving operation device 10 outputs a signal indicating the operation amount to the control unit 15.

The occupant monitoring device 11 monitors the state of the occupant in the passenger compartment. The occupant monitoring device 11 includes, for example, an internal camera 26 that images an occupant sitting on a seat in the vehicle cabin, and a grip sensor 27 provided on the steering wheel. The internal camera 26 is a digital camera using a solid-state imaging device such as a CCD and a CMOS. The grip sensor 27 is a sensor that detects if the driver is gripping the steering wheel, and outputs the presence or absence of the grip as a detection signal. The grip sensor 27 may be formed of a capacitance sensor or a piezoelectric device provided on the steering wheel. The occupant monitoring device 11 may include a heart rate sensor provided on the steering wheel or the seat, or a seating sensor provided on the seat. In addition, the occupant monitoring device 11 may be a wearable device that is worn by the occupant, and can detect the vital information of the driver including at least one of the heart rate and the blood pressure of the driver. In this conjunction, the occupant monitoring device 11 may be configured to be able to communicate with the control unit 15 via a per se known wireless communication means. The occupant monitoring device 11 outputs the captured image and the detection signal to the control unit 15.

The external notification device 14 is a device for notifying to people outside of the vehicle by sound and/or light, and may include a warning light and a horn. A headlight (front light), a taillight, a brake lamp, a hazard lamp, and a vehicle interior light may function as a warning light.

The HMI 12 notifies the occupant of various kinds of information by visual display and speech, and receives an input operation by the occupant. The HMI 12 may include at least one of a display device 31 such as a touch panel and an indicator light including an LCD or an organic EL, a sound generator 32 such as a buzzer and a speaker, and an input interface 33 such as a GUI switch on the touch panel and a mechanical switch. The navigation interface 23 may be configured to function as the HMI 12.

The autonomous driving level switch 13 is a switch that activates autonomous driving as an instruction from the driver. The autonomous driving level switch 13 may be a mechanical switch or a GUI switch displayed on the touch panel, and is positioned in a suitable part of the cabin. The autonomous driving level switch 13 may be formed by the input interface 33 of the HMI 12 or may be formed by the navigation interface 23.

The control unit 15 may consist of an electronic control unit (ECU) including a CPU, a ROM, a RAM, and the like. The control unit 15 executes various types of vehicle control by executing arithmetic processes according to a computer program executed by the CPU. The control unit 15 may be configured as a single piece of hardware, or may be configured as a unit including a plurality of pieces of hardware. In addition, at least a part of each functional unit of the control unit 15 may be realized by hardware such as an LSI, an ASIC, and an FPGA, or may be realized by a combination of software and hardware.

The control unit 15 is configured to execute autonomous driving control of at least level 0 to level 3 by combining various types of vehicle control. The level is according to the definition of SAE J3016, and is determined in relation to the degree of machine intervention in the driving operation of the driver and in the monitoring of the surrounding environment of the vehicle.

In autonomous driving of level 0, the control unit 15 does not control the vehicle, and the driver performs all of the driving operations. Thus, autonomous driving of level 0 means a manual driving.

In autonomous driving of level 1, the control unit 15 executes a certain part of the driving operation, and the driver performs the remaining part of the driving operation. For example, autonomous driving level 1 includes constant speed traveling, inter-vehicle distance control (ACC; Adaptive Cruise Control) and lane keeping assist control (LKAS; Lane Keeping Assistance System). The level 1 autonomous driving is executed when various devices (for example, the external environment recognition device 6 and the vehicle sensor 7) required for executing the level 1 autonomous driving are all properly functioning.

In autonomous driving of level 2, the control unit 15 performs the entire driving operation. The level 2 autonomous driving is performed only when the driver monitors the surrounding environment of the vehicle, the vehicle is within a designated area, and the various devices required for performing the level 2 autonomous driving are all functioning properly.

In level 3 autonomous driving, the control unit 15 performs the entire driving operation. The level 3 autonomous driving requires the driver to monitor or be aware of the surrounding environment when required, and is executed only when the vehicle is within a designated area, and the various devices required for performing the level 3 autonomous driving are all functioning properly. The conditions under which the level 3 autonomous driving is executed may include that the vehicle is traveling on a congested road. Whether the vehicle is traveling on a congested road or not may be determined according to traffic regulation information provided from a server outside of the vehicle, or, alternatively, that the vehicle speed detected by the vehicle speed sensor is determined to be lower than a predetermined slowdown determination value (for example, 30 km/h) over a predetermined time period.

Thus, in the autonomous driving of levels 1 to 3, the control unit 15 executes at least one of the steering, the acceleration, the deceleration, and the monitoring of the surrounding environment. When in the autonomous driving mode, the control unit 15 executes the autonomous driving of level 1 to level 3. Hereinafter, the steering, acceleration, and deceleration operations are collectively referred to as driving operation, and the driving and the monitoring of the surrounding environment may be collectively referred to as driving.

In the present embodiment, when the control unit 15 has received an instruction to execute autonomous driving via the autonomous driving level switch 13, the control unit 15 selects the autonomous driving level that is suitable for the environment of the vehicle according to the detection result of the external environment recognition device 6 and the position of the vehicle acquired by the navigation device 9, and changes the autonomous driving level as required. However, the control unit 15 may also change the autonomous driving level according the input to the autonomous driving level switch 13.

As shown in FIG. 1, the control unit 15 includes an autonomous driving control unit 35, an abnormal state determination unit 36, a state management unit 37, a travel control unit 38, and a storage unit 39.

The autonomous driving control unit 35 includes an external environment recognition unit 40, a vehicle position recognition unit 41, and an action plan unit 42. The external environment recognition unit 40 recognizes an obstacle located around the vehicle, the shape of the road, the presence or absence of a sidewalk, and road signs according to the detection result of the external environment recognition device 6. The obstacles include, not exclusively, guardrails, telephone poles, surrounding vehicles, and pedestrians. The external environment recognition unit 40 can acquire the state of the surrounding vehicles, such as the position, speed, and acceleration of each surrounding vehicle from the detection result of the external environment recognition device 6. The position of each surrounding vehicle may be recognized as a representative point such as a center of gravity position or a corner positions of the surrounding vehicle, or an area represented by the contour of the surrounding vehicle.

The vehicle position recognition unit 41 recognizes a traveling lane, which is a lane in which the vehicle is traveling, and a relative position and an angle of the vehicle with respect to the traveling lane. The vehicle position recognition unit 41 may recognize the traveling lane according to the map information stored in the map storage unit 22 and the position of the vehicle acquired by the GNSS receiver 21. In addition, the lane markings drawn on the road surface around the vehicle may be extracted from the map information, and the relative position and angle of the vehicle with respect to the traveling lane may be recognized by comparing the extracted lane markings with the lane markings captured by the external camera 19.

The action plan unit 42 sequentially creates an action plan for driving the vehicle along the route. More specifically, the action plan unit 42 first determines a set of events for traveling on the target lane determined by the route determination unit 24 without the vehicle coming into contact with an obstacle. The events may include a constant speed traveling event in which the vehicle travels in the same lane at a constant speed, a preceding vehicle following event in which the vehicle follows a preceding vehicle at a certain speed which is equal to or lower than a speed selected by the driver or a speed which is determined by the prevailing environment, a lane changing event in which the vehicle change lanes, a passing event in which the vehicle passes a preceding vehicle, a merging event in which the vehicle merge into the traffic from another road at a junction of the road, a diverging event in which the vehicle travels into a selected road at a junction of the road, an autonomous driving end event in which autonomous driving is ended, and the driver takes over the driving operation, and a stop event in which the vehicle is brought to a stop when a certain condition is met, the condition including a case where the control unit 15 or the driver has become incapable of continuing the driving operation.

The conditions under which the action plan unit 42 invokes the stop event include the case where an input to the internal camera 26, the grip sensor 27, or the autonomous driving level switch 13 in response to an intervention request (a hand-over request) to the driver is not detected during autonomous driving. The intervention request is a warning to the driver to take over a part of the driving, and to perform at least one of the driving operation and the monitoring of the environment corresponding to the part of the driving that is to be handed over. The condition under which the action plan unit 42 invokes the stop even include the case where the action plan unit 42 has detected that the driver has become incapable of performing the driving while the vehicle is traveling due to a physiological ailment according to the signal from a pulse sensor, the internal camera or the like.

During the execution of these events, the action plan unit 42 may invoke an avoidance event for avoiding an obstacle or the like according to the surrounding conditions of the vehicle (existence of nearby vehicles and pedestrians, lane narrowing due to road construction, etc.).

The action plan unit 42 generates a target trajectory for the vehicle to travel in the future corresponding to the selected event. The target trajectory is obtained by sequentially arranging trajectory points that the vehicle should trace at each time point. The action plan unit 42 may generate the target trajectory according to the target speed and the target acceleration set for each event. At this time, the information on the target speed and the target acceleration is determined for each interval between the trajectory points.

The travel control unit 38 controls the power unit 3, the brake device 4, and the steering device 5 so that the vehicle traces the target trajectory generated by the action plan unit 42 according to the schedule also generated by the action plan unit 42.

The storage unit 39 is formed by a ROM, a RAM, or the like, and stores information required for the processing by the autonomous driving control unit 35, the abnormal state determination unit 36, the state management unit 37, and the travel control unit 38.

The abnormal state determination unit 36 includes a vehicle state determination unit 51 and an occupant state determination unit 52. The vehicle state determination unit 51 analyzes signals from various devices (for example, the external environment recognition device 6 and the vehicle sensor 7) that affect the level of the autonomous driving that is being executed, and detects the occurrence of an abnormality in any of the devices and units that may prevent a proper execution of the autonomous driving of the level that is being executed.

The occupant state determination unit 52 determines if the driver is in an abnormal state or not according to a signal from the occupant monitoring device 11. The abnormal state includes the case where the driver is unable to properly steer the vehicle in autonomous driving of level 1 or lower that requires the driver to steer the vehicle. That the driver is unable to steer the vehicle in autonomous driving of level 1 or lower could mean that the driver is not holding the steering wheel, the driver is asleep, the driver is incapacitated or unconscious due to illness or injury, or the driver is under a cardiac arrest. The occupant state determination unit 52 determines that the driver is in an abnormal state when there is no input to the grip sensor 27 from the driver while in autonomous driving of level 1 or lower that requires the driver to steer the vehicle. Further, the occupant state determination unit 52 may determine the open/closed state of the driver's eyelids from the face image of the driver that is extracted from the output of the internal camera 26. The occupant state determination unit 52 may determine that the driver is asleep, under a strong drowsiness, unconscious or under a cardiac arrest so that the drive is unable to properly drive the vehicle, and the driver is in an abnormal condition when the driver's eyelids are closed for more than a predetermined time period, or when the number of times the eyelids are closed per unit time interval is equal to or greater than a predetermined threshold value. The occupant state determination unit 52 may further acquire the driver's posture from the captured image to determine that the driver's posture is not suitable for the driving operation or that the posture of the driver does not change for a predetermined time period. It may well mean that the driver is incapacitated due to illness or injury, and in an abnormal condition.

In the case of autonomous driving of level 2 or lower, the abnormal condition includes a situation where the driver is neglecting the duty to monitor the environment surrounding the vehicle. This situation may include either the case where the driver is not holding or gripping the steering wheel or the case where the driver's line of sight is not directed in the forward direction. The occupant state determination unit 52 may detect the abnormal condition where the driver is neglecting to monitor the environment surrounding the vehicle when the output signal of the grip sensor 27 indicates that the driver is not holding the steering wheel. The occupant state determination unit 52 may detect the abnormal condition according to the image captured by the internal camera 26. The occupant state determination unit 52 may use a per se known image analysis technique to extract the face region of the driver from the captured image, and then extracts the iris parts (hereinafter, iris) including the inner and outer corners of the eyes and pupils from the extracted face area. The occupant state determination unit 52 may detect the driver's line of sight according to the positions of the inner and outer corners of the eyes, the iris, the outline of the iris, and the like. It is determined that the driver is neglecting the duty to monitor the environment surrounding the vehicle when the driver's line of sight is not directed in the forward direction.

In addition, in the autonomous driving at a level where the drive is not required to monitor the surrounding environment or in the autonomous driving of level 3, an abnormal condition refers to a state in which the driver cannot promptly take over the driving when a driving takeover request is issued to the driver. The state where the driver cannot take over the driving includes the state where the system cannot be monitored, or, in other words, where the driver cannot monitor a screen display that may be showing an alarm display such as when the driver is asleep, and when the driver is not looking ahead. In the present embodiment, in the level 3 autonomous driving, the abnormal condition includes a case where the driver cannot perform the duty of monitoring the surrounding environment of the vehicle even though the driver is notified to monitor the surrounding environment of the vehicle. In the present embodiment, the occupant state determination unit 52 displays a predetermined screen on the display device 31 of the HMI 12, and instructs the driver to look at the display device 31. Thereafter, the occupant state determination unit 52 detects the driver's line of sight with the internal camera 26, and determines that the driver is unable to fulfill the duty of monitoring the surrounding environment of the vehicle if driver's line of sight is not facing the display device 31 of the HMI 12.

The occupant state determination unit 52 may detect if the driver is gripping the steering wheel according to the signal from the grip sensor 27, and if the driver is not gripping the steering wheel, it can be determined that the vehicle is in an abnormal state in which the duty of monitoring the surrounding environment the vehicle is being neglected. Further, the occupant state determination unit 52 determines if the driver is in an abnormal state according to the image captured by the internal camera 26. For example, the occupant state determination unit 52 extracts a driver's face region from the captured image by using a per se known image analysis means. The occupant state determination unit 52 may further extract iris parts (hereinafter, iris) of the driver including the inner and outer corners of the eyes and pupils from the extracted face area. The occupant state determination unit 52 obtains the driver's line of sight according to the extracted positions of the inner and outer corners of the eyes, the iris, the outline of the iris, and the like. It is determined that the driver is neglecting the duty to monitor the environment surrounding the vehicle when the driver's line of sight is not directed in the forward direction.

The state management unit 37 selects the level of the autonomous driving according to at least one of the own vehicle position, the operation of the autonomous driving level switch 13, and the determination result of the abnormal state determination unit 36. Further, the state management unit 37 controls the action plan unit 42 according to the selected autonomous driving level, thereby performing the autonomous driving according to the selected autonomous driving level. For example, when the state management unit 37 has selected the level 1 autonomous driving, and a constant speed traveling control is being executed, the event to be determined by the action plan unit 42 is limited only to the constant speed traveling event.

The state management unit 37 raises and lowers the autonomous driving level as required in addition to executing the autonomous driving according to the selected level.

More specifically, the state management unit 37 raises the level when the condition for executing the autonomous driving at the selected level is met, and an instruction to raise the level of the autonomous driving is input to the autonomous driving level switch 13.

When the condition for executing the autonomous driving of the current level ceases to be satisfied, or when an instruction to lower the level of the autonomous driving is input to the autonomous driving level switch 13, the state management unit 37 executes an intervention request process. In the intervention request process, the state management unit 37 first notifies the driver of a handover request. The notification to the driver may be made by displaying a message or image on the display device 31 or generating a speech or a warning sound from the sound generator 32. The notification to the driver may continue for a predetermined period of time after the intervention request process is started or may be continued until an input is detected by the occupant monitoring device 11.

The condition for executing the autonomous driving of the current level ceases to be satisfied when the vehicle has moved to an area where only the autonomous driving of a level lower than the current level is permitted, or when the abnormal state determination unit 36 has determined that an abnormal condition that prevents the continuation of the autonomous driving of the current level has occurred to the driver or the vehicle.

Following the notification to the driver, the state management unit 37 detects if the internal camera 26 or the grip sensor 27 has received an input from the driver indicating a takeover of the driving. The detection of the presence or absence of an input to take over the driving is determined in a way that depends on the level that is to be selected. When moving to level 2, the state management unit 37 extracts the driver's line of sight from the image acquired by the internal camera 26, and when the driver's line of sight is facing the front of the vehicle, it is determined that an input indicating the takeover of the driving by the driver is received. When moving to level 1 or level 0, the state management unit 37 determines that there is an input indicating an intent to take over the driving when the grip sensor 27 has detected the gripping of the steering wheel by the driver. Thus, the internal camera 26 and the grip sensor 27 function as an intervention detection device that detects an intervention of the driver to the driving. Further, the state management unit 37 may detect if there is an input indicating an intervention of the driver to the driving according to the input to the autonomous driving level switch 13.

The state management unit 37 lowers the autonomous driving level when an input indicating an intervention to the driving is detected within a predetermined period of time from the start of the intervention request process. At this time, the level of the autonomous driving after the lowering of the level may be level 0, or may be the highest level that can be executed.

The state management unit 37 causes the action plan unit 42 to generate a stop event when an input corresponding to the driver's intervention to the driving is not detected within a predetermined period of time after the execution of the intervention request process. The stop event is an event in which the vehicle is brought to a stop at a safe position (for example, an emergency parking zone, a roadside zone, a roadside shoulder, a parking area, etc.) while the vehicle control is degenerated. Here, a series of procedures executed in the stop event may be referred to as MRM (Minimum Risk Maneuver).

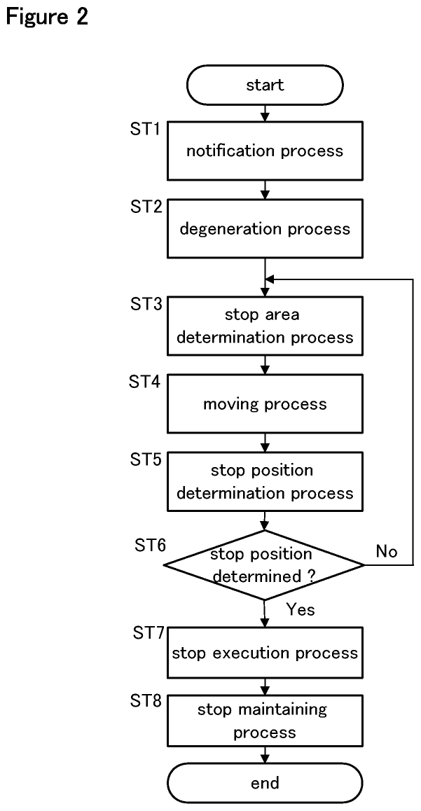

When the stop event is invoked, the control unit 15 shifts from the autonomous driving mode to the autonomous stopping mode, and the action plan unit 42 executes the stop process. Hereinafter, an outline of the stop process is described with reference to the flowchart of FIG. 2.

In the stop process, a notification process is first executed (ST1). In the notification process, the action plan unit 42 operates the external notification device 14 to notify the people outside of the vehicle. For example, the action plan unit 42 activates a horn included in the external notification device 14 to periodically generate a warning sound. The notification process continues until the stop process ends. After the notification process has ended, the action plan unit 42 may continue to activate the horn to generate a warning sound depending on the situation.

Then, a degeneration process is executed (ST2). The degeneration process is a process of restricting events that can be invoked by the action plan unit 42. The degeneration process may prohibit a lane change event to a passing lane, a passing event, a merging event, and the like. Further, in the degeneration process, the speed upper limit and the acceleration upper limit of the vehicle may be more limited in the respective events as compared with the case where the stop process is not performed.

Next, a stop area determination process is executed (ST3). The stop area determination process refers to the map information according to the current position of the own vehicle, and extracts a plurality of available stop areas (candidates for the stop area or potential stop areas) suitable for stopping, such as road shoulders and evacuation spaces in the traveling direction of the own vehicle. Then, one of the available stop areas is selected as the stop area by taking into account the size of the stop area, the distance to the stop area, and the like.

Next, a moving process is executed (ST4). In the moving process, a route for reaching the stop area is determined, various events along the route leading to the stop area are generated, and a target trajectory is determined. The travel control unit 38 controls the power unit 3, the brake device 4, and the steering device 5 according to the target trajectory determined by the action plan unit 42. The vehicle then travels along the route and reaches the stop area.

Next, a stop position determination process is executed (ST5). In the stop position determination process, the stop position is determined according to obstacles, road markings, and other objects located around the vehicle recognized by the external environment recognition unit 40. In the stop position determination process, it is possible that the stop position cannot be determined in the stop area due to the presence of surrounding vehicles and obstacles. When the stop position cannot be determined in the stop position determination process (No in ST6), the stop area determination process (ST3), the movement process (ST4), and the stop position determination process (ST5) are sequentially repeated.

If the stop position can be determined in the stop position determination process (Yes in ST6), a stop execution process is executed (ST7). In the stop execution process, the action plan unit 42 generates a target trajectory according to the current position of the vehicle and the targeted stop position. The travel control unit 38 controls the power unit 3, the brake device 4, and the steering device 5 according to the target trajectory determined by the action plan unit 42. The vehicle then moves toward the stop position and stops at the stop position.

After the stop execution process is executed, a stop maintaining process is executed (ST8). In the stop maintaining process, the travel control unit 38 drives the parking brake device according to a command from the action plan unit 42 to maintain the vehicle at the stop position. Thereafter, the action plan unit 42 may transmit an emergency call to the emergency call center by the communication device 8. When the stop maintaining process is completed, the stop process ends.

When the driver wishes to take over the driving during autonomous driving, it is desirable if the driver is able to cancel autonomous driving not only by operating the autonomous driving level switch 13 or the input interface 33 but also by operating the steering wheel, an accelerator pedal or the brake pedal. However, during autonomous driving, the driver may carelessly place his hand on the steering wheel or put his foot on the accelerator pedal or brake pedal, and this may inadvertently cause the steering wheel, the accelerator pedal or the brake pedal to be operated. To overcome this problem, the control unit 15 is incorporated with a threshold value for an operation amount for each of the steering wheel, an accelerator pedal and the brake pedal. Thus, for each of the steering wheel, an accelerator pedal and the brake pedal, when the operation amount has exceeded the threshold value, the control unit 15 causes the autonomous driving to be interrupted, and allows the driver to take over the driving. When the operation amount is equal to or less than the threshold value, the control unit 15 determines that the operation is not intended, and the performed operation is disregarded without interrupting the autonomous driving.

In the following disclosure, an operation mode that does not require the intervention of the driver, such as autonomous driving of level 3, is referred to as an autonomous driving mode, and an operation mode based on MRM is referred to as an autonomous stopping mode. The autonomous stopping mode is activated when the driver fails to acknowledge a request for intervention (handover request) within a prescribed time period after a handover request is made via a notification interface such as the display device 31 and the sound generator 32. The acknowledgement of the handover request may be detected when the autonomous driving level switch 13 is operated or when the input interface 33 detects an input thereto. When the autonomous stopping mode is activated, the control unit 15 autonomously drive the vehicle to the stop position of the stop area (steps ST3 to ST7 in FIG. 2).

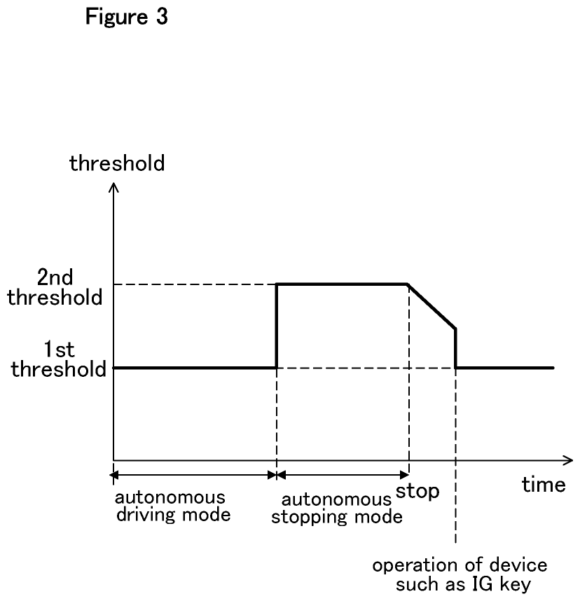

In the autonomous stopping mode, the driver may have lost consciousness or otherwise in an abnormal condition so that an operation of a large operation amount may be applied inadvertently. Under such a condition, a handover should not be requested. Based on such a consideration, the control unit 15 changes the threshold depending on the operating condition of the vehicle as shown in FIG. 3. In the autonomous driving mode, the threshold is set to a first threshold. In the autonomous stopping mode, the threshold is set to a second threshold larger than the first threshold. This can prevent the responsibility of driving the vehicle from being transferred to the driver on account of an unintended operation performed by the driver. In addition, by setting the second threshold larger than the first threshold, when the driving responsibility is transferred to the driver, an arrangement may be made to warn or solicit the driver to drive the vehicle with a strong will or with a conscious effort.

Once the vehicle comes to a stop in the autonomous stopping mode, the threshold value gradually decreases. After the vehicle has completely stopped, the driver may have regained sense or calmness to such an extent to be able to operate the vehicle to a certain extent. In such a case, the driver may be allowed to operate the vehicle depending on the situation. The threshold value after the autonomous stopping may not gradually decrease, but may decrease in a stepwise manner such that the final threshold of the stop maintaining process (ST8 in FIG. 2) may be the same as or different from the first threshold value. Further, the decrease in the threshold value may be started immediately after the vehicle comes to a stop, or may be started after a predetermined time has elapsed after the vehicle has come to a stop.

Also, when a deliberate operation is performed (or when the driver has intentionally performed a certain operation) on other devices 61 (see FIG. 1) such as the ignition key, the shift lever and the a door lock device during the stop maintaining process following the autonomous stop, the responsibility of driving is handed over to the driver. The convenience of the driver is improved by expanding or relaxing the restriction on the means for canceling the stop maintaining process. Upon transferring the driving responsibility to the driver, the control unit 15 may either maintain the same threshold which is equal to the first threshold or reduce the threshold to a value lower than the first threshold.

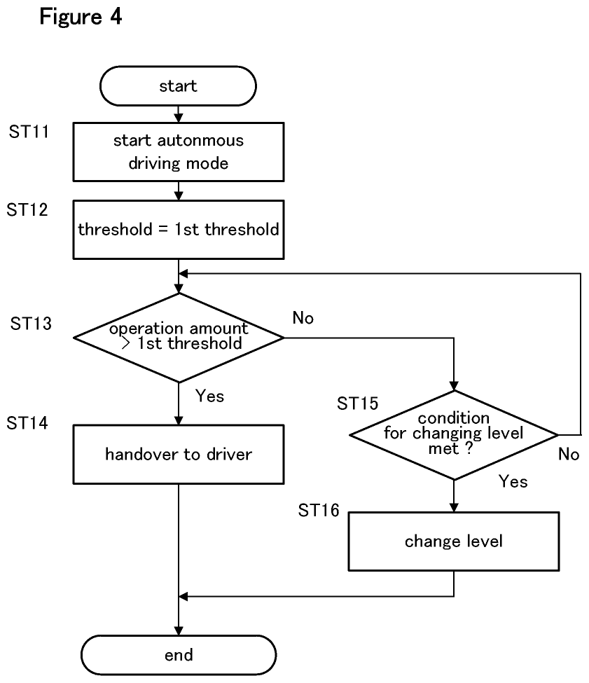

With reference to FIG. 4, a process of transferring the driving responsibility to the driver during the autonomous driving mode is described in the following by taking the operation of the steering wheel as an example. Upon starting the autonomous driving mode (ST11), the control unit 15 sets the threshold to the first threshold (ST12). When the steering wheel is operated, the control unit 15 compares the operation amount (angle) with the first threshold value (ST13). If the operation amount is greater than the first threshold, the driving responsibility is transferred to the driver (ST14). At this time, the transferred driving responsibility may be limited to the steering wheel, but may also cover the acceleration and/or deceleration of the vehicle. If the operation amount is equal to or smaller than the first threshold, the autonomous driving is maintained, and the driving responsibility is not transferred to the driver. However, when the control unit 15 receives an instruction to end the autonomous driving mode such as when switching of the autonomous driving level switch 13 is detected, the autonomous driving is canceled or the autonomous driving level is changed (ST16).

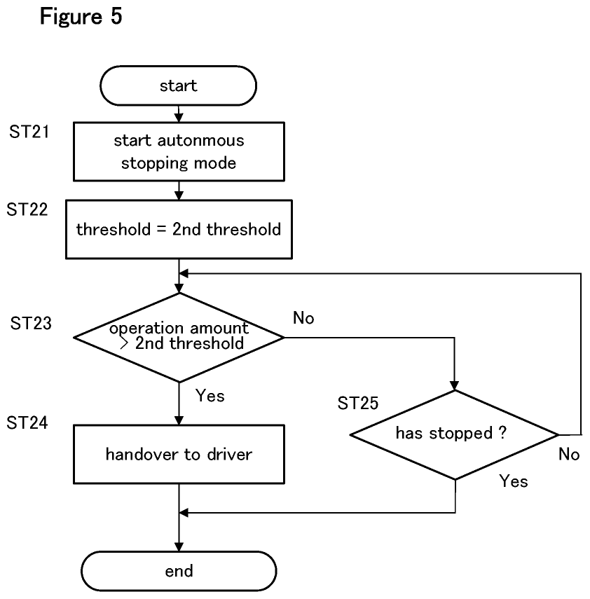

With reference to FIG. 5, a process of transferring the driving responsibility to the driver when executing the autonomous stopping mode is described in the following in regard to the operation of the steering wheel as an example. Upon requesting a driving intervention to the driver during the execution of the autonomous driving mode, the control unit 15 executes the autonomous stopping mode if the driver does not input the acceptance of the driving intervention request (handover request) within a predetermined time (ST21), and sets the threshold a second threshold larger than the first threshold (ST22). At this time, if the steering wheel is operated, the control unit 15 compares the operation amount (angle) with a second threshold value (ST23). If the operation amount exceeds the second threshold value, the control unit 15 transfers the driving responsibility in regard to steering to the driver. (ST24). Optionally, the driving responsibility in regard to acceleration/deceleration may also be transferred.

At this time, the control unit 15 may immediately transfer the driving responsibility to the driver. However, in order to enhance safety, the control unit 15 may notify the transfer of the driving responsibility to the driver via the display device 31 and/or the sound generator 32, and then transfer the driving responsibility after elapsing of a prescribed time period after the notification. If the operation amount is equal to or less than the second threshold, the control unit 15 continues the autonomous stopping mode until the vehicle comes to a stop (ST25).

When an operation amount equal to or less than the first threshold value is applied in the autonomous driving mode, and when the operation amount equal to or less than the second threshold value is applied in the autonomous stopping mode, the control unit 15 may apply a reaction force counteracting this operation amount to the steering wheel to return the steering wheel to the original position. Therefore, when the driver intends to operate the steering wheel by an operation amount larger than the threshold, the steering wheel is required to be turned against this reaction force. Thus, if the driver unintentionally turns the steering wheel, this reaction force will cause the steering wheel to return to the original position thereof before the threshold is exceeded. The control unit 15 sets the second threshold value for the operation of the accelerator pedal and the brake pedal, but may not apply a reaction force even if the operation amount is equal to or less than the threshold value.

During the autonomous stopping mode, the driver is required to turn the steering wheel against the reaction force of the second threshold value larger than the first threshold value for the driving responsibility to be transferred to the driver so that a deliberate effort is required for the steering wheel to be turned. In this way, by setting the second threshold larger than the first threshold, and applying the reaction force to the steering wheel, the driver is required to demonstrate a deliberate effort to accept the driving intervention request when switching from the autonomous driving mode to the autonomous stopping mode. Further, if the driver turns the steering wheel unintentionally, the second threshold value is larger than the first threshold value, and the reaction force is so strong that the operation amount does not easily exceed the second threshold value, and the autonomous stopping mode is continued. As a result, safety is enhanced.

The steering wheel was taken as an example in the foregoing description, but the same applies to the operation of the accelerator pedal and the brake pedal, except that no reaction force may be applied to an operation amount equal to or less than the threshold value. When the operation amount of any one of the steering wheel, the accelerator pedal, and the brake pedal has exceeded the corresponding threshold, the driving responsibility may be transferred to driver for steering and acceleration/deceleration. Alternatively, when the operation amounts of both the steering wheel and the accelerator pedal have exceeded the threshold value, or when the operation amounts of both the steering wheel and the brake pedal have exceeded the threshold value, the driving responsibility may be transferred to driver for steering and acceleration/deceleration.

Also, in the autonomous driving mode, when the gripping of the steering wheel by the driver is detected by the grip sensor 27, the driving responsibility in regard to steering and acceleration/deceleration may be transferred to the driver. In the autonomous stopping mode, when the gripping of the steering wheel by the driver is detected and the operation amount of at least one of the steering wheel, the accelerator pedal, and the brake pedal have exceeded the second threshold, the driving responsibility for steering and acceleration/deceleration may be transferred to the driver. As described above, in the autonomous stopping mode, by confirming the driver's intention to intervene in driving by using two or more driving intention accepting devices, it is possible to ensure that the driver has the intention to drive, and the driving responsibility can be transferred to the driver in a reliable manner.

Further, in the autonomous stopping mode, it may be arranged such that the control unit 15 causes the hazard lamp to blink, and the driving responsibility is transferred to the driver when the switch (one of the other devices 61) for turning off the hazard lamp is pressed. Thereby, the convenience for the driver is improved. Further, since it is unlikely that the driver unintentionally presses the switch for turning off the hazard lamp, the possibility of the driving responsibility being erroneously transferred to the driver who is unable to accept the request to take over the responsibility of driving can be minimized.

The determination to transfer the driving responsibility to the driver in the autonomous stopping mode may also take into account the determination result of the occupant state determination unit 52 (see FIG. 1). When the occupant state determination unit 52 determines that the driver is in an abnormal state, the operation mode may be returned to the autonomous stopping mode once again.

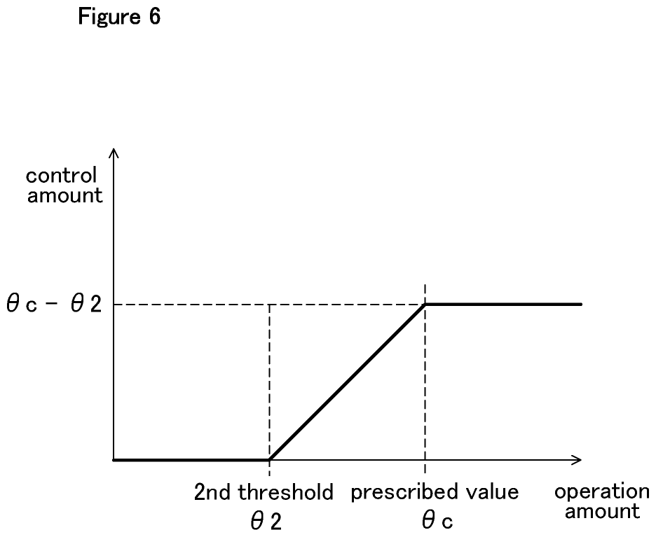

Further, as shown in FIG. 6, when the operation amount of the operation started during the execution of the autonomous stopping mode exceeds a predetermined value (θc) larger than the second threshold value (θ2), the control unit 15 transfers the responsibility of the driving to the driver, but causes a part of the operation amount exceeding the prescribed value (θc) to be not reflected in the control of the vehicle.

Thus, if the operation amount is equal to or less than the second threshold value, the autonomous stopping mode is continued. If the operation amount exceeds the second threshold value and is equal to or less than the predetermined value, the driving responsibility for the operation is transferred to the driver, and the operation amount minus the second threshold is reflected in the control of the vehicle. If the operation amount exceeds the predetermined value, the predetermined value minus the second threshold is reflected in the control of the vehicle. Thereby, even when the driver overreacts to the activation of the autonomous stopping mode, the resulting excessive operation amounts are reduced in effect so that sudden steering, sudden acceleration and sudden deceleration can be avoided.

The present invention has been described in terms of a specific embodiment, but is not limited by such embodiment, but can be modified in various ways without departing from the scope of the present invention. The present invention can be applied not only to the autonomous stopping mode of level 3 autonomous driving, but the autonomous stopping mode of autonomous driving of other levels.

1. A vehicle control system configured for autonomous driving, comprising:
a control unit for steering, accelerating and decelerating a vehicle;
a notification interface configured to notify a handover request issued by the control unit to a driver of the vehicle; and
an intervention detection unit for detecting an intention of the driver to accept the handover request;
wherein the autonomous driving includes an autonomous driving mode in which the vehicle is operated without requiring an intervention of the driver at least in regard to steering or acceleration/deceleration of the vehicle, and an autonomous stopping mode in which the vehicle is brought to a stop in a prescribed stop area when it is detected that the control unit or the driver has become incapable of properly maintaining a traveling state of the vehicle; and
wherein the intervention detection unit includes an operation input unit configured to accept a steering operation and/or an accelerating/decelerating operation by the driver: the control unit transferring driving responsibility in regard to the operation input unit to the driver when an operation amount applied to the operation input unit exceeds a first threshold when the autonomous driving mode is being executed, and when an operation amount applied to the operation input unit exceeds a second threshold greater than the first threshold when the autonomous stopping mode is being executed.

2. The vehicle control system according to claim 1, wherein the second threshold is lowered gradually or in a stepwise manner with time after the vehicle is brought to a stop in the autonomous stopping mode.

3. The vehicle control system according to claim 1, wherein the control unit at least partly transfers driving responsibility to the driver when an ignition key, a shift lever or a door lock device is operated after the vehicle is brought to a stop in the autonomous stopping mode.

4. The vehicle control system according to claim 1, wherein the operation input unit includes a steering wheel, an accelerator pedal and a brake pedal, and when operation amounts of the steering wheel and the accelerator pedal both exceed the second threshold, or when operation amounts of the steering wheel and the brake pedal both exceed the second threshold, the driving responsibility in regard to the associated part of the operation input unit is transferred to the driver.

5. The vehicle control system according to claim 1, wherein the operation input unit includes a steering wheel, an accelerator pedal and a brake pedal, and the intervention detection unit includes a grip sensor (27) provided on the steering wheel to detect if the driver is holding the steering wheel, and
wherein the control unit transfers the driving responsibility to the driver when the grip sensor indicates that the driver is holding the steering wheel in the autonomous driving mode, and transfers the driving responsibility to the driver when the grip sensor indicates that the driver is holding the steering wheel, and the operation amount of the operation input unit exceeds the second threshold in the autonomous stopping mode.

6. The vehicle control system according to claim 1, further comprising a hazard lamp that can be turned on to indicate an activation of the autonomous stopping mode, and a manual switch to turn off the hazard lamp, and the driving responsibility is transferred to the driver when the hazard lamp which was turned on upon activation of the autonomous stopping mode is manually turned off by the driver.

7. The vehicle control system according to claim 1, wherein the operation input unit includes a steering wheel, and the control unit is configured to apply a reaction force to the steering wheel opposing a steering input thereto when an operation amount applied thereto is below the thresholds.

8. The vehicle control system according to claim 1, wherein in executing the autonomous stopping mode, when the operation amount exceeds a prescribed value higher than the second threshold, the control unit prevents a part of the operation amount exceeding the prescribed value from being reflected in controlling the vehicle.
